(19) United States
(12) Patent Application Publication
(10) Pub. No.: US 2020/0200245 A1
(43) Pub. Date: Jun. 25, 2020

(54) Ball Screw Drive With Variable Spring Stiffness

(71) Applicant: Schaeffler Technologies AG & Co. KG, Herzogenaurach (DE)

(72) Inventor: Michael Zinnecker, Berkley, MI (US)

(73) Assignee: Schaeffler Technologies AG & Co. KG, Herzogenaurach (DE)

(21) Appl. No.: 16/127,291

(22) Filed: Sep. 11, 2018

(51) Int. Cl. F16H 25/24; F16H 25/22

(52) U.S. Cl. CPC F16H 25/2427; F16F 1/3713; F16H 25/2214

(57) ABSTRACT

Ball screw drives are disclosed. The ball screw may include a spindle having a threaded portion; a nut having a threaded portion, the threaded portions of the spindle and the nut together forming a ball channel; and a plurality of balls disposed in the ball channel to form a ball chain. Two or more intermediate springs may be disposed within the ball chain, each intermediate spring disposed between two balls in the ball chain. At least two of the two or more intermediate springs may have a different spring stiffness.

### TECHNICAL FIELD

The present disclosure relates generally to a ball screw drive, for example, having a variable spring stiffness and/or force.

### BACKGROUND

Ball screws are mechanical actuators that translate rotational motion to linear motion or linear motion to rotational motion, typically with low friction. Ball screws generally include a spindle nut which is arranged rotatably on a threaded spindle, with balls being interposed. Ball screws may be used in a variety of applications, such as power-assisted steering gears or parking systems of motor vehicles.

### SUMMARY

In at least one embodiment, a ball screw is provided. The ball screw may include a spindle having a threaded portion; a nut having a threaded portion, the threaded portions of the spindle and the nut together forming a ball channel; and a plurality of balls disposed in the ball channel to form a ball chain. Two or more intermediate springs may be disposed within the ball chain, each intermediate spring disposed between two balls in the ball chain. At least two of the two or more intermediate springs may have a different spring stiffness.

In one embodiment, a first intermediate spring with a greater spring stiffness of the at least two intermediate springs is located at a first position in the ball chain and a second intermediate spring with a lower spring stiffness of the at least two intermediate springs is located at a second position in the ball chain, the first position being configured to receive a higher load than the second position. The different spring stiffness may be due to a difference in length of the intermediate springs, a difference in a diameter of the intermediate springs, a difference in a wire diameter of the intermediate springs, a difference in a number of coils per unit length of the intermediate springs, and/or a difference in materials or material properties of the intermediate springs.

In one embodiment, three or more intermediate springs are disposed within the ball chain, each intermediate spring being disposed between two balls in the ball chain; and at least three of the three or more intermediate springs have a different spring stiffness. In another embodiment, the balls within the ball chain do not recirculate or leave the ball channel.

### BRIEF DESCRIPTION OF THE DRAWINGS

FIG. 1 is a perspective view of a ball screw, according to an embodiment;

FIG. 2 is a perspective view of FIG. 1 with the nut removed;

FIG. 3A is an exploded view of a ball screw, according to an embodiment;

FIG. 3B is a perspective view of a ball chain including intermediate springs, according to an embodiment; and

FIG. 4 is a perspective view of a nut, according to an embodiment.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

Ball screws can be categorized into different types, such as those with inner deflection, those with outer deflection, those that are non-recirculating (e.g., no deflection), or others. Where inner deflection is concerned, a plurality of ball chains are often provided which extend in each case over about 360 degrees. The ball track extends over about 360 degrees, that is to say winds approximately once about the axis of rotation. The spindle nut has arranged in it deflection inserts which deflect the ball chain from the end of the ball track towards its start and at the same time lift the balls over the thread flank of the threaded spindle. Where outer deflection is concerned, the ball chain, that is to say the ball track, often extends over a plurality of turns; the deflection piece is often arranged outside the spindle nut and, according to the length of the ball chain, spans a number of turns, that is to say thread flanks. However, these descriptions are merely examples, and the exact configurations may vary, as understood by a person of ordinary skill in the art.

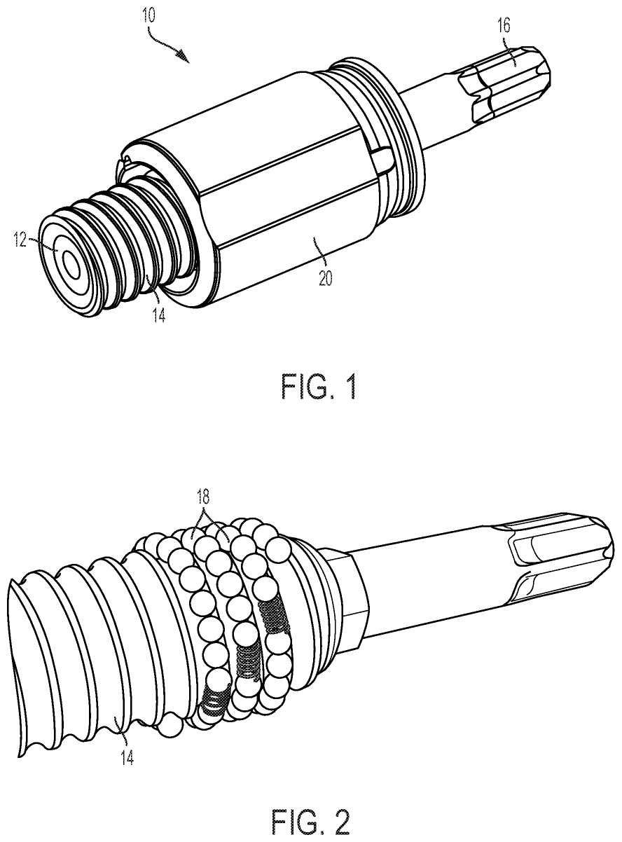

With reference to FIGS. 1-3, embodiments of a non-recirculating ball screw 10 is shown (also called a ball screw drive). FIG. 1 shows an example of the ball screw 10 in an assembled state. The ball screw 10 includes a spindle 12, which includes a thread 14 (e.g., helical thread) and a splined portion 16 on one end that is configured to engage another component. For example, the splined portion 16 may engage (directly or indirectly) an actuator that may rotate the spindle 12. A plurality of balls 18 or rolling bodies (covered in FIG. 1), which may be referred to as a ball chain, may be arranged in the thread 14, which may also be referred to as a ball channel. A nut 20, also called a spindle nut, may be arranged on the spindle 12 and may include a thread corresponding to the thread 14 to form a second half or portion of the ball channel. Accordingly, the balls 18 may be disposed in the thread 14 between the spindle 12 and the nut 20 when the ball screw 10 is assembled. When the spindle 12 is rotated and the nut is restricted from rotational movement, the balls 18 may move along the thread 14, causing the nut 20 to move along a longitudinal axis of the spindle 12, thereby translating rotational motion to linear motion.

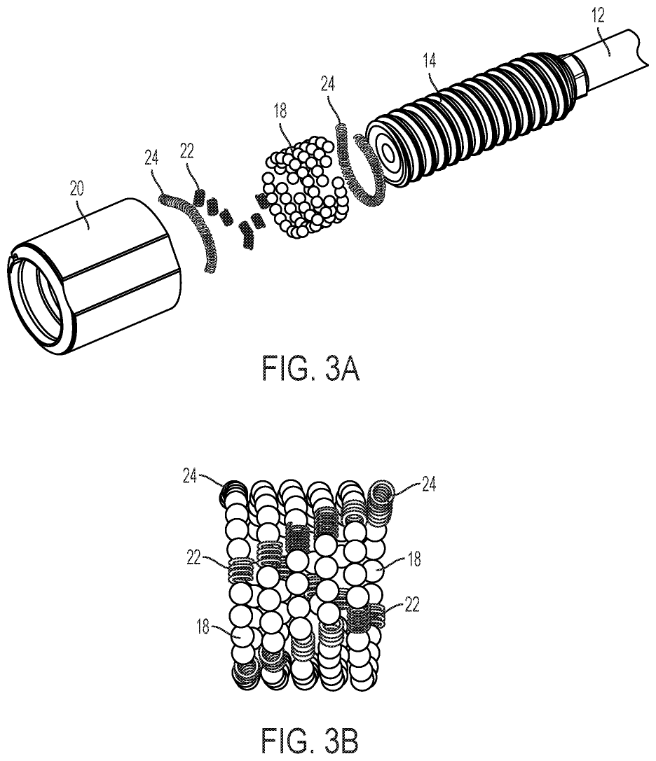

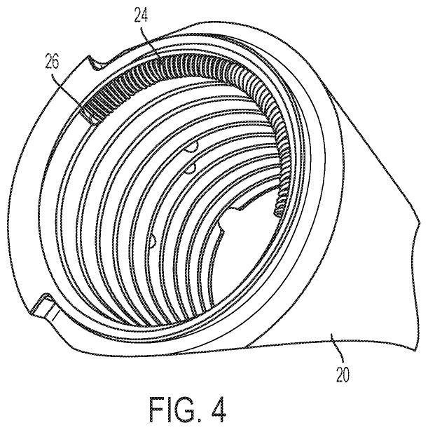

With reference to FIG. 2, the ball screw 10 is shown with the nut 20 removed. As shown, the balls 18 are arranged in the thread 14 and are formed in a ball chain. Disposed within the ball chain are spacers 22 which, in the embodiment shown, are springs. The springs are disposed between sets of one or more balls 18 and may therefore be referred to as intermediate springs. The balls between each intermediate spring may be referred to as a ball chain segment or a sub-chain. The intermediate springs 22 may reduce the friction of the balls 18 with respect to one another, improve the efficiency of the ball screw 10, and/or reduce wear on the balls 18. The intermediate springs 22 may be distributed uniformly between the balls 18 (e.g., the same number of balls are in each chain segment—four balls in FIG. 3B), however, in other embodiments there may be a variable number of balls 18 between adjacent springs 22. As described above, the spacers 22 may be springs, such as helical springs. However, other elastic materials capable of deforming and returning to their original shape may be used, such as elastomeric springs.

With reference to FIG. 3A, an exploded view of the ball screw 10 is shown. FIG. 3B shows the isolated ball chain including the intermediate springs 22. The balls 18 are configured such that they stay within the ball channel and are not recirculated. The balls 18 may be maintained in a certain axial region by two end spacers 24, one located on each end of the ball chain. Similar to the spacers 22, the spacers 24 may be springs or other elastic materials. The spacers 24 may be the same as the spacers 22 (e.g., in shape and/or material) or they may be different. Each end spring 24 may be disposed between one end of the ball chain and a stop 26. An example of a stop 26 is shown in FIG. 4. The stop 26 may be any physical structure that provides a surface to receive an end of the spring 24 and prevent it from moving thereby. Accordingly, the stop 26 may allow the end spring 24 to exert a force on the ball chain and prevent the ball chain from moving beyond the predetermined axial region. The stops 26 may be formed integral with the nut 20 or they may be separate pieces that are disposed within the nut and cooperate with the nut to perform the stopping function. In one example, the stop 26 may be a pin the extends through a wall of the nut 20.

In some embodiments, each intermediate spring 22 may be the same—e.g., the same material, size/shape, and properties. However, in operation, the ball chain may experience different forces at different locations within the ball chain. In these situations, the springs 22 that experience a higher force may tend to compress or settle over time. This may reduce the effectiveness of the springs 22 in evenly distributing forces within the ball chain. In at least one embodiment, there may be at least two different types of intermediate springs 22 within the ball chain. As used herein, a different type of spring may be a spring having a different size/shape, material, or properties. Examples of differences in size/shape may include the length of the spring, the overall width of the spring, the width of the spring wire itself, or the number of coils per unit length. These differences may result in a different spring stiffness or spring constant (k). One or more of these factors may be varied to cause an increase (or decrease) in the spring stiffness compared to the other springs. For example, the material of the wire/coil may be changed, the wire/coil thickness may be changed (increased or decreased), the overall spring width may be changed (increased or decreased), the number of coils per unit length may be changed (increased or decreased), or the length of the spring may be changed (increased or decreased), or any combination thereof.

Accordingly, the ball screw 10 may include at least two intermediate springs 22 that have a different spring stiffness. The two or more spring stiffnesses may apply to the intermediate springs independent of the end springs 24 (e.g., if the end springs also have a different stiffness then there may be three different stiffnesses). In other embodiments, there may be more than two different spring stiffnesses within the intermediate springs 22, such as at least 3, 4, or 5 different stiffnesses. The number of different stiffnesses may depend on the design of the ball screw 10 and/or the application.

The intermediate spring(s) 22 having a greater stiffness may be disposed at locations within the ball chain that are configured to experience higher forces. This may be determined by experimental studies or computational methods, such as by finite element analysis (FEA). The threshold for deciding if a certain intermediate spring will be replaced with a higher stiffness spring may depend on the ball screw design and/or the application. In one example, if the spring is configured or expected to experience a force a certain factor or percentage above an average force of the intermediate springs, it may be replaced with a higher stiffness spring. However, this is merely one potential criteria, and one of ordinary skill in the art will understand, based on the present disclosure, that other criteria may be used.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

Ball Screw 10
Spindle 12
Thread 14
Splined Portion 16
Balls 18
Nut 20
Intermediate Springs 22
End Springs 24
End Stop 26

What is claimed is:

1. A ball screw, comprising:
a spindle having a threaded portion;
a nut having a threaded portion, the threaded portions of the spindle and the nut together forming a ball channel;
a plurality of balls disposed in the ball channel to form a ball chain; and
two or more intermediate springs disposed within the ball chain, each intermediate spring disposed between two balls in the ball chain;
wherein at least two of the two or more intermediate springs have a different spring stiffness.

2. The ball screw of claim 1, wherein a first intermediate spring with a greater spring stiffness of the at least two intermediate springs is located at a first position in the ball chain and a second intermediate spring with a lower spring stiffness of the at least two intermediate springs is located at a second position in the ball chain, the first position being configured to receive a higher load than the second position.

3. The ball screw of claim 1, wherein the different spring stiffness is due to a difference in length of the intermediate springs.

4. The ball screw of claim 1, wherein the different spring stiffness is due to a difference in a diameter of the intermediate springs.

5. The ball screw of claim 1, wherein the different spring stiffness is due to a difference in a wire diameter of the intermediate springs.

6. The ball screw of claim 1, wherein the different spring stiffness is due to a difference in a number of coils per unit length of the intermediate springs.

7. The ball screw of claim 1, wherein the different spring stiffness is due to a difference in materials or material properties of the intermediate springs.

8. The ball screw of claim 1, wherein three or more intermediate springs are disposed within the ball chain, each intermediate spring being disposed between two balls in the ball chain; and at least three of the three or more intermediate springs have a different spring stiffness.

9. The ball screw of claim 1, wherein the balls within the ball chain do not recirculate or leave the ball channel.
